(19) United States
(12) Patent Application Publication
(10) Pub. No.: US 2009/0297919 A1
(43) Pub. Date: Dec. 3, 2009

(54) GAS DIFFUSION LAYER OF PROTON EXCHANGE MEMBRANE FUEL CELL SYSTEM

(75) Inventors: Chun-Wei Peng, Taoyuan Hsien (TW); Chin-Yuan Chiu, Taoyuan Hsien (TW)

Correspondence Address: KIRTON AND MCCONKIE, 60 EAST SOUTH TEMPLE,, SUITE 1800, SALT LAKE CITY, UT, 84111, US

(73) Assignee: DELTA ELECTRONICS, INC., Taoyuan Hsien (TW)

(21) Appl. No.: 12/469,908

(22) Filed: May 21, 2009

(30) Foreign Application Priority Data
May 27, 2008 (TW) 097119477

(51) Int. Cl. H01M 2/00

(52) U.S. Cl. 429/34

(57) ABSTRACT

A fuel cell unit of a proton exchange membrane fuel cell system includes a pair of flow field plates and a membrane electrode assembly. The membrane electrode assembly is interposed between the pair of flow field plates to define respective reactant flow channels with the pair of flow field plates. The membrane electrode assembly includes an anode catalyst layer, a cathode catalyst layer, a proton exchange membrane and a pair of gas diffusion layers. The gas diffusion layers are respectively disposed adjacent to the anode catalyst layer and the cathode catalyst layer and face to the flow field plates. At least one of the gas diffusion layers has a fluid permeability distribution profile increasing first and then decreasing from an inlet to an outlet of the reactant flow channel. The gas diffusion layer has the maximum fluid permeability at the site with the highest rate of reaction.

### FIELD OF THE INVENTION

The present invention relates to a gas diffusion layer (GDL) of a fuel cell, and more particularly to a gas diffusion layer of a proton exchange membrane fuel cell system.

### BACKGROUND OF THE INVENTION

Recently, the ecological problems resulted from fossil fuels such as petroleum and coal have been greatly noticed all over the world. Consequently, there are growing demands on clean energy. Among various energy sources, fuel cells are expected as an alternative to fossil fuel energy systems. Fuel cells produce electrical energy by means of electrochemical reactions. Comparing to the conventional power generation apparatus, fuel cells have advantages of less pollutant, lower noise, increasing energy density and higher energy conversion efficiency. Fuel cells can be used in portable electronic products, staitionary applications or power generation systems, transportations, military equipment, and the space industry etc.

According to types of the electrolytes, there are a variety of fuel cells, e.g. an alkaline fuel cell (AFC), a phosphoric acid fuel cell (PAFC), a molten carbonate fuel cell (MCFC), a solid oxide fuel cell (SOFC) and a proton exchange membrane fuel cell system (PEMFC). Depending on types of the fuel cells, the operation principles are somewhat different. Among these, the proton exchange membrane fuel cell system (PEMFC) is one of the most prevailing fuel fuels because PEMFC has a relatively higher volumetric energy density, a lower operating temperature and no electrolyte leakage problem.

FIG. 1 schematically illustrates a fuel cell unit of a proton exchange membrane fuel cell system according to the prior art. As shown in FIG. 1, the fuel cell 21 unit principally comprises a proton exchange membrane 11, anode/cathode catalyst layers 12, anode/cathode gas diffusion layers 13 and anode/cathode flow field plates 14. When the fuel (e.g. hydrogen) enters the fuel cell 21 through the flow field plate 14 and is distributed uniformly by the gas diffusion layer 13, the fuel will reach the active site on catalyst layer 12 and start reaction to produce electron and proton. The proton will be transported from anode to cathode through the membrane 11. And the electron will be transported from anode to cathode by external circuit (not shown). In cathode, the oxidant (e.g. air or oxygen) also enters the fuel cell 21. Then, the oxidant will react with proton and electron from anode, and produce water and electricity.

In the proton exchange membrane fuel cell system, the proton exchange membrane 11, the anode/cathode catalyst layers 12 and the gas diffusion layers 13 are cooperatively referred as a membrane electrode assembly (MEA). Generally, the performance of the proton exchange membrane fuel cell system is dominantly dependent on the performance of MEA. As a result, many researches are concentrated on the improvement of MEA to provide more convenient, economical and durable products.

In the membrane electrode assembly, the gas diffusion layers 13 play very important roles. For example, the gas diffusion layers 13 have functions of: (1) introducing fuel or oxidant (e.g. air or oxygen), (2) exhausting reactant (e.g. water etc.), (3) transferring electrons and (4) providing mechanical enforcement of the membrane electrode assembly.

In particular, the functions (1) and (2) are very critical and thus several operating parameters or conditions should be taken into consideration. For example, if the speed of introducing fuel or oxygen (or ambient air) is too quick or too slow, the limit current of the membrane electrode assembly is adversely affected. In addition, the capability of conducting water is very important for the gas diffusion layers. If the gas channels in the gas diffusion layers are blocked by the produced water, the fuel or oxidant (e.g. air or oxygen) fails to be conducted to reacting sites (i.e. the catalyst layers) and thus the overall efficiency of the fuel cell system is impaired. In the sites near the entrance of the flow field plate, the reaction rate is slower, so that the amount of produced water is usually insufficient to facilitate permeation of the protons through the proton exchange membrane and thus the overall efficiency of the fuel cell system is undesired.

For gas diffusion layer, how to keep the speed of introducing fuel or oxidant, the capability of conducting water and the amount of produced water required for the proton exchange membrane at the same time is very important, especially when the rates of reactions or temperatures are not usually identical through whole MEA, it adds more challenge to achieve an optimal combination of these items.

For meeting the target mentioned last paragraph, some researchers tried to use non-uniform gas diffusion layer instead of conventional uniform gas diffusion layer, just like someone, for example, perforating gas diffusion layer in a non-uniform manner. However, this will incurs some drawbacks. For example, if some catalyst granules are trapped into the perforation of the gas diffusion layer, so that the gas diffusion layer is blocked and thus the performance of the membrane electrode assembly is impaired.

In addition, the patterns of the perforations of the gas diffusion layer are linearly increased or decreased from the inlet to the outlet. In practical applications, however, the rate of reactions do not linearly increase or decrease along the flow path. Hence, if the density of perforations of the gas diffusion layer increases linearly along the flow path from the inlet to the outlet, some drawbacks will occur. Firstly, since the perforations at the outlet have relatively larger diameter, the produced water at the outlet are possibly returned back to the gas diffusion layer so as to block the gas flow path. Secondly, the presence of the produced water are necessary to the transportation of the protons through the proton exchange membrane, and if lack of water, the transportation of proton will be slowed down. So, we should keep the balance between the removal and production of the produced water. If the rate of reaction at the outlet is too low, a too high density of perforations may result in excess removal of the produced water and thus the performance of the membrane electrode assembly is impaired.

Therefore, there is a need of providing an improved gas diffusion layer of a proton exchange membrane fuel cell system to obviate the drawbacks encountered from the prior art.

### SUMMARY OF THE INVENTION

It is an object of the present invention to provide a gas diffusion layer having a non-linearly hydrophobicity distribution, porosity distribution or thickness distribution corresponding to the rate of reaction for balancing the fluid permeability of the gas diffusion layer and the humidity of the proton exchange membrane and enhancing the performance of the membrane electrode assembly (or the proton exchange membrane fuel cell system).

In accordance with an aspect of the present invention, there is provided a fuel cell unit of a proton exchange membrane fuel cell system. The fuel cell unit includes a pair of flow field plates and a membrane electrode assembly. The membrane electrode assembly is interposed between the pair of flow field plates to define respective reactant flow channels with the flow field plates. Each of the reactant flow channels includes at least an inlet and at least an outlet for providing accesses of a fluid fuel and removal of a reaction product, respectively. The membrane electrode assembly includes an anode catalyst layer, a cathode catalyst layer, a proton exchange membrane and a pair of gas diffusion layers. The proton exchange membrane allows protons formed at the anode catalyst layer to permeate therethrough to the cathode catalyst layer. The gas diffusion layers are respectively disposed adjacent to the anode catalyst layer and the cathode catalyst layer and face to the flow field plates. The gas diffusion layers allow the fluid fuel to be delivered therethrough to the anode catalyst layer and the cathode catalyst layer, so that allow the reaction product generated at the cathode catalyst layer to be transferred therethrough to the reactant flow channels. At least one of the gas diffusion layers has a fluid permeability distribution profile increasing first and then decreasing from the inlet to the outlet of the reactant flow channel. Wherein, the gas diffusion layer has the maximum fluid permeability at the site with the highest rate of reaction.

In accordance with another aspect of the present invention, there is provided a membrane electrode assembly of a fuel cell unit of a proton exchange membrane fuel cell system. The membrane electrode assembly includes an anode catalyst layer, a cathode catalyst layer, a proton exchange membrane and a pair of gas diffusion layers. The proton exchange membrane allows protons formed at the anode catalyst layer to permeate therethrough to the cathode catalyst layer. The gas diffusion layers are respectively disposed adjacent to the anode catalyst layer and the cathode catalyst layer and face to flow field plates of the fuel cell unit to define respective reactant flow channels with the flow field plates. The gas diffusion layers allow a fluid fuel to be delivered therethrough to the anode catalyst layer and the cathode catalyst layer, so that allow a reaction product generated at the cathode catalyst layer to be transferred therethrough to the reactant flow channels. At least one of the gas diffusion layers has a fluid permeability distribution profile increasing first and then decreasing from an inlet to an outlet of the reactant flow channel. Wherein, the gas diffusion layer has the maximum fluid permeability at the site with the highest rate of reaction.

In accordance with another aspect of the present invention, there is provided a gas diffusion layer of a membrane electrode assembly of a proton exchange membrane fuel cell system. The gas diffusion layer has a fluid permeability distribution profile increasing first and then decreasing from a starter site to a terminal site along a flow path. Wherein, the gas diffusion layer has the maximum fluid permeability at the site with the highest rate of reaction.

The above contents of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates a fuel cell unit of a proton exchange membrane fuel cell system according to the prior art;

FIG. 2A schematically illustrates a fuel cell unit of a proton exchange membrane fuel cell system according to a preferred embodiment of the present invention;

FIG. 2B schematically illustrates relations between the gas diffusion layer and the reactant flow channel;

FIG. 3 schematically illustrates comparison of simulated (lines) and measured (symbols) current density distributions;

FIG. 4 schematically illustrates a gas diffusion layer with variable porosity according to the present invention;

FIG. 5A and 5B schematically illustrate two examples of a gas diffusion layer with variable thickness according to the present invention;

FIG. 6A is a graph illustrating a fuel cell voltage (in volts) versus current density (in mA/cm²) for three proton exchange membranes fuel cell systems having different gas diffusion layers in whole-wet states; and

FIG. 6B is a graph illustrating a fuel cell voltage (in volts) versus current density (in mA/cm²) for three proton exchange membranes fuel cell systems having different gas diffusion layers in semi-wet states.

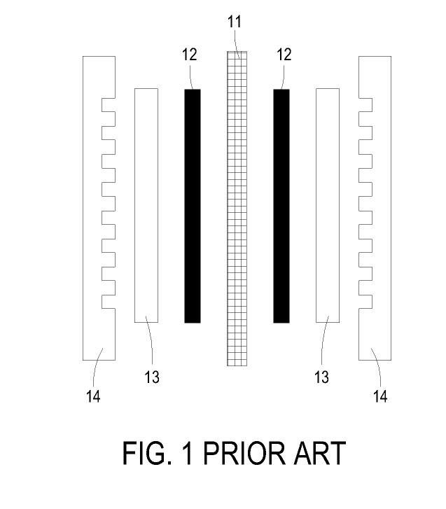

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

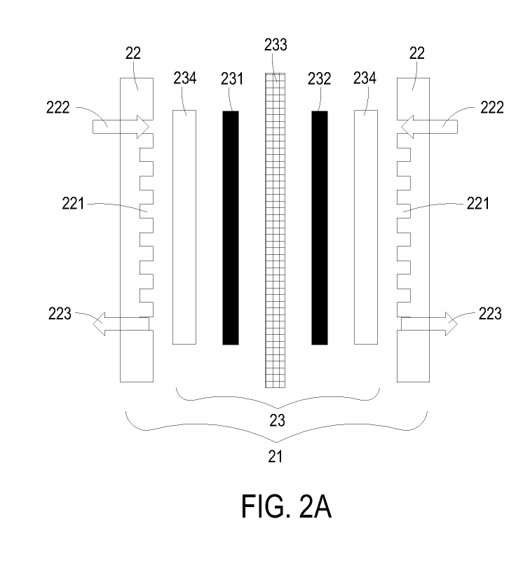

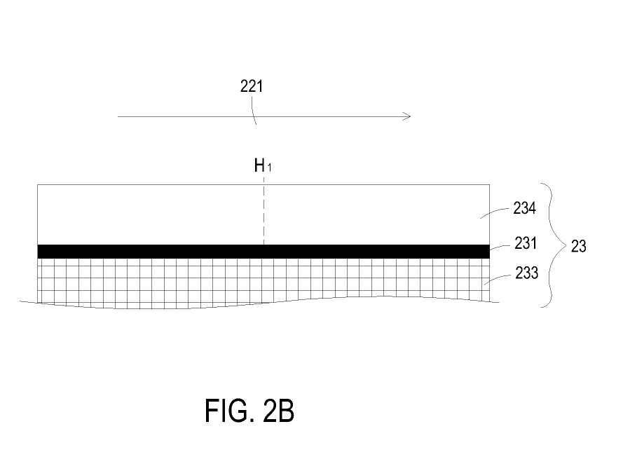

FIG. 2A schematically illustrates a fuel cell unit of a proton exchange membrane fuel cell (PEMFC) system according to a preferred embodiment of the present invention. The proton exchange membrane fuel cell system can transform the chemical energy to electrical energy by the electrochemical reaction of a fluid fuel, wherein the fuel is, for example, including liquid fuel or a gaseous fuel, and oxidant. As shown in FIG. 2A, the fuel cell unit 21 principally comprises a membrane electrode assembly (MEA) 23 and a pair of flow field plates 22. The membrane electrode assembly 23 is interposed between the pair of flow field plates 22 to define respective reactant flow channels 221 at the anode and cathode sides. Each reactant flow channel 221 includes at least an inlet 222 and at least an outlet 223 for providing accesses of the fluid fuel and removal of the reaction product (e.g. water), respectively.

In this embodiment, the membrane electrode assembly 23 comprises an anode catalyst layer 231, a cathode catalyst layer 232, a proton exchange membrane 233, and a pair of gas diffusion layers 234. The proton exchange membrane 233 is arranged between the anode catalyst layer 231 and the cathode catalyst layer 232. The protons formed at the anode catalyst layer 231 permeate through the proton exchange membrane 233 to the cathode catalyst layer 232. One gas diffusion layer 234 is arranged between one flow field plate 22 and the anode catalyst layer 231. The other gas diffusion layer 234 is arranged between the other flow field plate 22 and the cathode catalyst layer 232. Through the gas diffusion layers 234, the reactant flow is delivered to the anode catalyst layer 231 and the cathode catalyst layer 232, and thus the reaction product (e.g. water) generated at the cathode catalyst layer 232 is transferred to the reactant flow channels 221.

In practical applications, the rate of reaction does not linearly increase or decrease along the flow path from the inlet to the outlet of the reactant flow channel. The rate of reaction is complicatedly influenced by various factors, just like what described by H. Ju, C. Y. Wang, S. Cleghorn and U. Beuscher, “Non-isothermal Modeling of Polymer Electrolyte Fuel Cells Part I: Experimental Validation”, in Journal of The Electrochemical Society, Vol. 152, pp. A1645-1653, 2005, and the contents of which are hereby incorporated by reference.

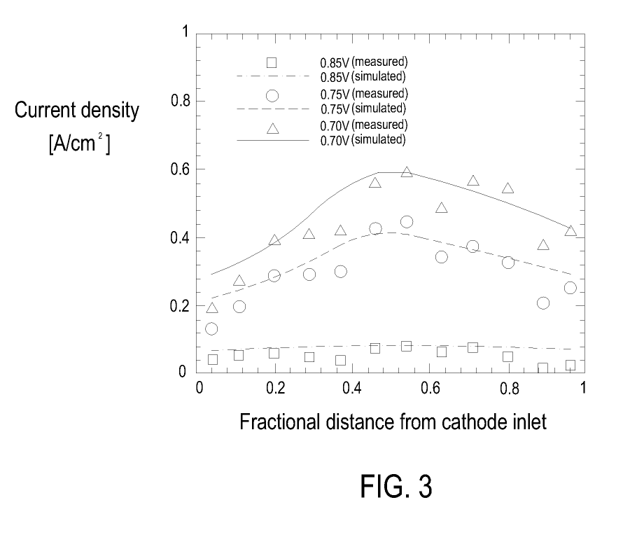

FIG. 3 schematically illustrates comparison of simulated (lines) and measured (symbols) current density distributions disclosed in the literature of Ju et al. As shown in FIG. 3, the rate of reaction is not linearly distributed along the flow path from the inlet to the outlet of the reactant flow channel 21. The rate of reaction increases from the inlet to about mid-point along the flow path and then decreases from the point to the outlet. Corresponding to the rate of reaction, the gas diffusion layer 234 of the present invention has non-linear fluid permeability distribution. In other words, the fluid permeability of the gas diffusion layer 234 increases from the inlet to about mid-point along the flow path and then decreases from the point to the outlet. Consequently, the fluid permeability of the gas diffusion layers 234 is highest when the rate of reaction reaches the maximum. For enhancing the performance of the fuel cell unit 21, the fluid permeability of the gas diffusion layer 234 and the humidity of the proton exchange membrane 233 should be taken into consideration at the same time, then it could prevent from excess accumulation or excess removal of the product water generated at the cathode side.

FIG. 2B schematically illustrates relations between the gas diffusion layer 234 and the reactant flow channel 221. For clarification, the reactant flow channel 221 is deemed as a linear channel. The arrow shows the general direction of the reactant flow from the inlet to the outlet of the reactant flow channel 221. The fluid permeability of the gas diffusion layer 234 gradually increases to the maximum value H₁ from the inlet to the approximately mid-point and then gradually decreases from the point to the outlet. In other words, the fluid permeability of the gas diffusion layer 234 increases first and then decreases from the starter site to the terminal site, wherein the fluid permeability is maximum at around mid-point. In accordance with the present invention, the fluid permeability distribution profile of the gas diffusion layer 234 may be adjusted by changing the porosity distribution, the hydrophilicity/hydrophobicity distribution and/or the thickness distribution of the gas diffusion layer 234.

The operation principle of the above fuel cell unit 21 will be illustrated in more details as follows. First of all, a stream of fuel (e.g. hydrogen gas) is fed into the inlet 222 of the reactant flow channel 221 and delivered to the anode catalyst layer 231 of the membrane electrode assembly 23. At the anode catalyst layer 231, the fuel is catalytically split into protons (H⁺) and electrons (e⁻). The protons (H⁺) formed at the anode catalyst layer 231 permeate through the proton exchange membrane 233 to the cathode catalyst layer 232. The electrons (e⁻) travel along an external load circuit to the cathode side of the membrane electrode assembly 23. Meanwhile, a stream of oxidant (e.g. air or oxygen (O₂)) is delivered to the cathode side of the membrane electrode assembly 23. At the cathode catalyst layer 232, for example, oxygen (O₂) molecules react with the protons (H⁺) and the electrons (e⁻) to form water molecules (H₂O).

As shown in FIG. 3, the current density (A/m²) at the cathode side from the inlet 222 to the outlet 223 of the reactant flow channel 221 is not linearly distributed. In other words, the rate of reaction increases first and then decreases from the inlet 222 to the outlet 223 of the reactant flow channel 221. As previously described, the fluid permeability distribution profile of the gas diffusion layer 234 is dependent on the hydrophobicity distribution, the porosity distribution and/or the thickness of the gas diffusion layer 234. For example, since the rate of reaction at the inlet 222 or the outlet 223 is relatively slow, smaller amount of product water is generated. For retaining the product water and thus facilitating permeation of the protons through the proton exchange membrane 233, the gas diffusion layer 234 has a higher hydrophobicity, a lower porosity and/or a larger thickness at the inlet 222 or the outlet 223 of the reactant flow channel 221. Whereas, the rate of reaction at approximately mid-point of the reactant flow channel 221 is very rapid. For facilitating removal of the produced water, the gas diffusion layer 234 has a lower hydrophobicity, a higher porosity and/or a smaller thickness at the mid-point of the reactant flow channel 221. As a result, the balance between the fluid permeability of the gas diffusion layer 234 and the humidity of the proton exchange membrane 233 are kept well.

In some embodiments, the fluid permeability distribution profile of the gas diffusion layer 234 is obtained by changing the hydrophilicity distribution of the gas diffusion layer 234. Like the current density distribution as shown in FIG. 3, the hydrophobicity distribution has the minimum value at approximately mid-point of the reactant flow channel 221 and a smaller value at the inlet 222 and/or the outlet 223 of the reactant flow channel 221. In this embodiment, for example, the value of the hydrophobity distribution at the outlet 223 is slightly lower than that at the inlet 222. The gas diffusion layer 234 used in the present invention is preferably made of carbonaceous material such as carbon cloth, carbon paper or carbon fiber. By adjusting contents of the hydrophobic agents contained in the gas diffusion layer 234 and/or the property of the carbonaceous material, the hydrophobicity distribution of the gas diffusion layer 234 is variable. The hydrophobic agents used in the present invention are preferably fluorine-containing material such as polytetrafluoroethene (PTFE), perfluoroethylene-propylene (FEP) and polyvinylidene fluoride (PVDF), and so on.

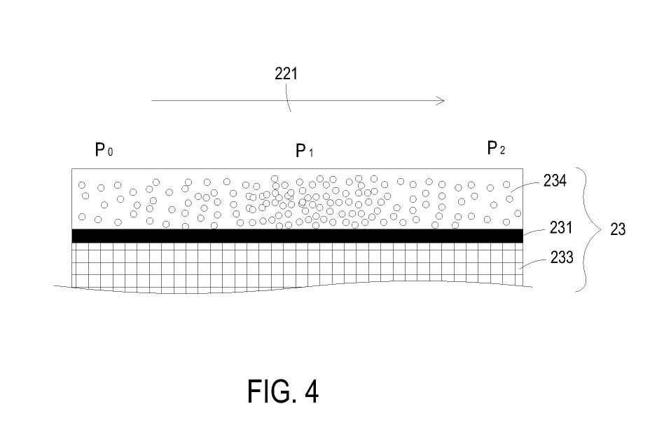

FIG. 4 schematically illustrates a gas diffusion layer with variable porosity according to the present invention. In this embodiment, the fluid permeability distribution profile of the gas diffusion layer 234 is obtained by changing the porosity distribution of the gas diffusion layer 234. As shown in FIG. 4, the porosity of the gas diffusion layer 234 increases from P₀ at the inlet 222 to P₁ at approximately mid-point of the reactant flow channel 221. The porosity of the gas diffusion layer 234 decreases from P₁ at approximately mid-point to P2 at the outlet 223 of the reactant flow channel 221. The porosity distribution of the gas diffusion layer 234 is determined when the carbon cloth, carbon paper or carbon fiber is fabricated or when a micro-porous layer (MPL) is applied. Since the rate of reaction at the inlet 222 (P₀) and/or the outlet 223 (P₂) is relatively slower than that at approximately mid-point (P₁), smaller amount of produced water is generated at the inlet 222 and/or the outlet 223. For retaining the produced water and thus facilitating permeation of the protons through the proton exchange membrane 233, the gas diffusion layer 234 has a lower porosity at the inlet 222 and/or the outlet 223 of the reactant flow channel 221. At approximately mid-point of the reactant flow channel 221 where the rate of reaction is very rapid, thus the gas diffusion layer 234 has a higher porosity facilitating removal of the excess produced water. In other words, the porosity distribution has the maximum value at approximately mid-point of the reactant flow channel 221 and a smaller value at the inlet 222 and/or the outlet 223 of the reactant flow channel 221. In this embodiment, for example, the value of the porosity distribution profile at the outlet 223 is slightly larger than that at the inlet 222, i.e. P₁>P₂>P₀.

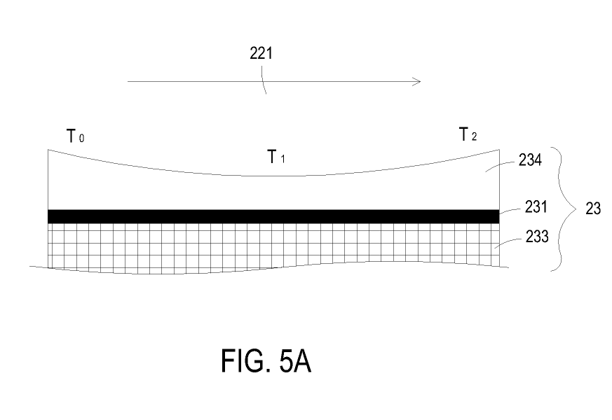

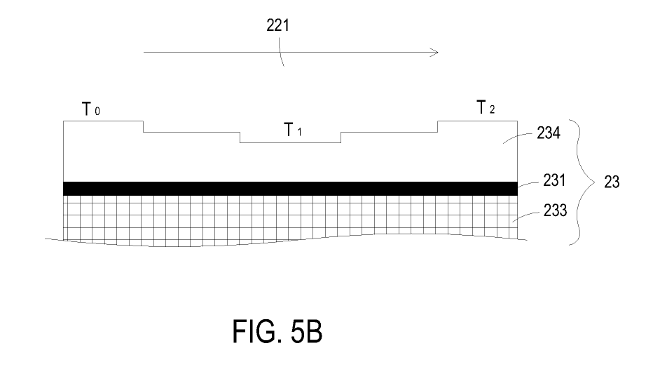

FIG. 5A and 5B schematically illustrate two examples of a gas diffusion layer with variable thickness according to the present invention. In this embodiment, the fluid permeability distribution profile of the gas diffusion layer 234 is obtained by changing the thickness distribution of the gas diffusion layer 234. As shown in FIG. 5A, the thickness of the gas diffusion layer 234 decreases from T₀ at the inlet 221 to T₁ at approximately mid-point of the reactant flow channel 221. The thickness of the gas diffusion layer 234 increases from T₁ at approximately mid-point to T₂ at the outlet 223 of the reactant flow channel 221. In other words, the thickness distribution has the minimum value at approximately mid-point of the reactant flow channel 221 and a larger value at the inlet 222 and/or the outlet 223 of the reactant flow channel 221. In this embodiment, for example, the value of the thickness distribution profile at the inlet 222 is slightly larger than that at the outlet 223, i.e. T₀>T₂>T₁.

As shown in FIG. 5A, the thickness distribution of the gas diffusion layer 234 is subject to continuous variations. That is, the thickness of the gas diffusion layer 234 continuously decreases from T₀ at the inlet 222 to T₁ at approximately mid-point of the reactant flow channel 221 and then continuously increases from T₁ at approximately mid-point to T₂ at the outlet 223 of the reactant flow channel 221. Similarly, the hydrophobicity distribution or the porosity distribution may be subject to continuous variations. Alternatively, the hydrophobicity distribution, the porosity distribution or the thickness distribution of the gas diffusion layer 234 may be subject to stepped variations. As shown in FIG. 5B, the thickness of the gas diffusion layer 234 decreases stepwise from T₀ at the inlet 222 to T₁ at approximately mid-point of the reactant flow channel 221 and then increases stepwise from T₁ at approximately mid-point to T₂ at the outlet 223 of the reactant flow channel 221.

In some embodiments, at least two of the hydrophilicity distribution, the porosity distribution and the thickness distribution of the gas diffusion layer 234 may be adjusted to achieve a desired fluid permeability distribution profile of the gas diffusion layer 234.

From the above description, the gas diffusion layer 234 of the present invention has a non-linear hydrophobicity distribution, porosity distribution or thickness distribution corresponding to the rate of reaction. For example, since the rate of reaction at the inlet 222 and/or the outlet 223 of the reactant flow channel 221 is relatively slow, thus smaller amount of produced water is generated. For retaining the produced water and thus facilitating permeation of the protons through the proton exchange membrane 233, the gas diffusion layer 234 has a higher hydrophobicity, a lower porosity and/or a larger thickness at the inlet 222 and/or the outlet 223 of the reactant flow channel 221. Whereas, the rate of reaction at approximately mid-point of the reactant flow channel 221 is very rapid. For facilitating removal of the produced water, the gas diffusion layer 234 has a lower hydrophobicity, a higher porosity and/or a smaller thickness at approximately mid-point of the reactant flow channel 221.

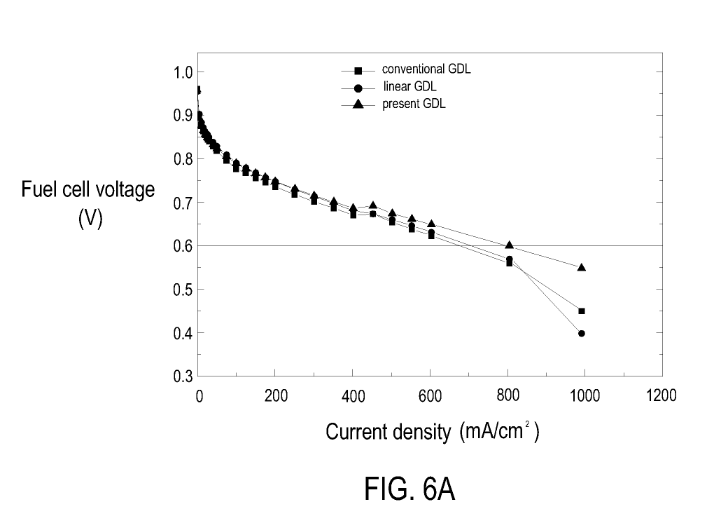

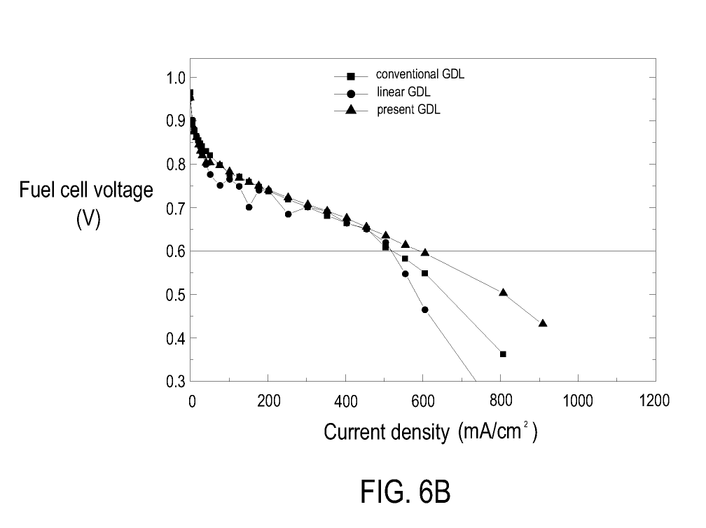

FIG. 6A is a graph illustrating a fuel cell voltage (in volts) versus current density (in mA/cm²) for three proton exchange membranes fuel cell systems having different gas diffusion layers in whole-wet states. FIG. 6B is a graph illustrating a fuel cell voltage (in volts) versus current density (in mA/cm²) for three proton exchange membranes fuel cell systems having different gas diffusion layers in semi-wet states. The experiments demonstrate that the proton exchange membrane fuel cell system having the gas diffusion layer 234 of the present invention has a relatively higher fuel cell voltage when the current density is identical. Since the balance between the fluid permeability of the gas diffusion layer 234 and the humidity of the proton exchange membrane 233is well, the performance of the membrane electrode assembly 23 (or the proton exchange membrane fuel cell system 21) is enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A fuel cell unit of a proton exchange membrane fuel cell system, said fuel cell unit comprising:
a pair of flow field plates; and
a membrane electrode assembly interposed between said pair of flow field plates to define respective reactant flow channels with said flow field plates, each of said reactant flow channel including at least an inlet and at least an outlet for providing access of a fluid fuel and removal of a reaction product, respectively, wherein said membrane electrode assembly comprises:
an anode catalyst layer;
a cathode catalyst layer;
a proton exchange membrane allowing protons formed at said anode catalyst layer to permeate therethrough to said cathode catalyst layer; and
a pair of gas diffusion layers respectively disposed adjacent to said anode catalyst layer and said cathode catalyst layer and face to said flow field plates allowing said fluid fuel to be delivered therethrough to said anode catalyst layer and said cathode catalyst layer and allowing said reaction product generated at said cathode catalyst layer to be transferred therethrough to said reactant flow channels, wherein at least one of said gas diffusion layers has a fluid permeability distribution profile increasing first and then decreasing from said inlet to said outlet of said reactant flow channel, and said gas diffusion layer has the maximum fluid permeability at the site with the highest rate of reaction.

2. The fuel cell unit according to claim 1 wherein said fluid fuel is a liquid fuel or a gaseous fuel.

3. The fuel cell unit according to claim 1 wherein said fluid permeability distribution profile of said gas diffusion layer is dependent on a hydrophobicity distribution, a porosity distribution and/or a thickness of said gas diffusion layer.

4. The fuel cell unit according to claim 3 wherein said hydrophobicity distribution of said gas diffusion layer decreases first and then increases from said inlet to said outlet of said reactant flow channel, and said gas diffusion layer has the maximum hydrophobicity at the site with the highest rate of reaction.

5. The fuel cell unit according to claim 4 wherein said gas diffusion layer is made of carbonaceous material, and said hydrophobicity distribution of said gas diffusion layer is variable by adjusting contents of hydrophobic agents contained in said gas diffusion layer and/or the property of said carbonaceous material.

6. The fuel cell unit according to claim 3 wherein said porosity distribution of said gas diffusion layer increases first and then decreases from said inlet to said outlet of said reactant flow channel, and said gas diffusion layer has the maximum porosity at the site with the highest rate of reaction.

7. The fuel cell unit according to claim 3 wherein said thickness distribution of said gas diffusion layer decreases first and then increases from said inlet to said outlet of said reactant flow channel, and said gas diffusion layer has the minimum thickness at the site with the highest rate of reaction.

8. The fuel cell unit according to claim 3 wherein said fluid permeability distribution profile of said gas diffusion layer is subject to continuous or stepped variations.

9. The fuel cell unit according to claim 1 wherein said reaction product is water.

10. A membrane electrode assembly of a fuel cell unit of a proton exchange membrane fuel cell system, said fuel cell unit comprising a pair of flow field plates, said membrane electrode assembly comprising:
an anode catalyst layer;
a cathode catalyst layer;
a proton exchange membrane allowing protons formed at said anode catalyst layer to permeate therethrough to said cathode catalyst layer; and
a pair of gas diffusion layers respectively disposed adjacent to said anode catalyst layer and said cathode catalyst layer and face to said flow field plates to define respective reactant flow channels with said flow field plates, said gas diffusion layers allowing a fluid fuel to be delivered therethrough to said anode catalyst layer and said cathode catalyst layer and allowing a reaction product generated at said cathode catalyst layer to be transferred therethrough to said reactant flow channels, wherein at least one of said gas diffusion layers has a fluid permeability distribution profile increasing first and then decreasing from an inlet to an outlet of said reactant flow channel, and said gas diffusion layer has the maximum fluid permeability at the site with the highest rate of reaction.

11. The membrane electrode assembly according to claim 10 wherein said fluid permeability distribution profile of said gas diffusion layer is dependent on a hydrophobicity distribution, a porosity distribution and/or a thickness of said gas diffusion layer.

12. A gas diffusion layer of a membrane electrode assembly of a proton exchange membrane fuel cell system, said gas diffusion layer having a fluid permeability distribution profile increasing first and then decreasing from a starter site to a terminal site along a flow path, wherein said gas diffusion layer has the maximum fluid permeability at the site with the highest rate of reaction.
